(19) United States
(12) Patent Application Publication
(10) Pub. No.: US 2014/0058602 A1
(43) Pub. Date: Feb. 27, 2014

(54) HYBRID VEHICLE

(71) Applicants: Yukihiro Hosoe, Hamamatsu-shi (JP); Yoshiki Ito, Hamamatsu-shi (JP); Masaaki Tagawa, Hamamatsu-shi (JP); Hitoshi Ohkuma, Hamamatsu-shi (JP)

(72) Inventors: Yukihiro Hosoe, Hamamatsu-shi (JP); Yoshiki Ito, Hamamatsu-shi (JP); Masaaki Tagawa, Hamamatsu-shi (JP); Hitoshi Ohkuma, Hamamatsu-shi (JP)

(21) Appl. No.: 13/982,792

(22) PCT Filed: Feb. 4, 2011
(86) PCT No.: PCT/JP2011/052371

§ 371 Date: Nov. 11, 2013

(51) Int. Cl. B60W 20/00; B60W 10/08; B60W 10/06

(52) U.S. Cl. CPC B60W 20/108; B60W 10/06; B60W 10/08; Y10S 903/93
USPC 701/22; 180/65.265; 903/930

(57) ABSTRACT

It is an object of the invention to suppress a vibration generated by an abrupt change in motor torque when starting an engine.

In a hybrid vehicle which outputs power generated from an engine and a motor generator to a drive shaft through a power transmitting mechanism, the hybrid vehicle includes: a compensation torque calculating means which calculates an inertia compensation torque for compensating a change in the rotation speed of the engine generated by an inertia at the time of a gear shifting operation; and a target torque calculating means which corrects a target torque of the motor generator based on the inertia compensation torque calculated by the compensation torque calculating means, wherein the compensation torque calculating means corrects the inertia compensation torque when starting the engine.

### TECHNICAL FIELD

The present invention relates to a hybrid vehicle, and particularly, to a hybrid vehicle which uses an engine and a motor generator as power sources. More specifically, the invention relates to a hybrid vehicle capable of effectively suppressing a vibration generated when starting and stopping an engine.

### BACKGROUND ART

Hitherto, there has been proposed a hybrid vehicle which includes a motor generator other than an engine as running power sources, and for example, a hybrid vehicle disclosed in Japanese Unexamined Patent Application Publication No. 2007-118696 is known.

In the related art disclosed in the publication, an engine rotation speed is not changed before and after a gear shifting operation by correcting a target torque using an inertia compensation torque calculated in advance in order to suppress a gear shifting shock generated by an inertia of a motor generator or a control delay when determining the target torque of the motor generator.

### CITATION LIST

### Patent Literature

[PTL 1] Japanese Unexamined Patent Application Publication No. 2007-118696

### SUMMARY OF INVENTION

### Technical Problem

However, in the related art of PTL 1, there is no description for a technique of suppressing a vibration generated when starting and stopping the engine. In a case where the engine is started by correcting the target torque of the motor generator only by the inertia compensation torque, the inertia compensation torque is added to a cranking torque of the motor generator, and an abrupt change in torque occurs immediately after starting the cranking operation. As a result, a problem arises in that a driver feels uncomfortable or unpleasant. Further, in a case where the engine is stopped by correcting the target torque only by the inertia compensation torque, particularly a hybrid vehicle having a one-way clutch provided in an engine shaft has a problem below. At the moment in which the engine is stopped, the target engine rotation speed is suppressed to 0 by the inertia compensation torque of the motor generator, and hence a stop shock is transmitted to the output shaft by using the one-way clutch as a support point. As a result, a problem arises in that a driver feels uncomfortable or unpleasant.

It is an object of the invention to suppress a vibration generated by an abrupt change in motor torque when starting an engine.

### Solution to Problem

According to the invention, there is provided a hybrid vehicle which outputs power generated from an engine and a motor generator to a drive shaft through a power transmitting mechanism, the hybrid vehicle including: a compensation torque calculating means which calculates an inertia compensation torque for compensating an inertia torque generated by a change in the rotation speed of the engine and the motor generator; and a target torque calculating means which corrects a target torque of the motor generator based on the inertia compensation torque calculated by the compensation torque calculating means, wherein the compensation torque calculating means corrects the inertia compensation torque when starting the engine.

### Advantageous Effects of Invention

According to the invention, since the inertia compensation torque for compensating the variation in the engine rotation speed is corrected when starting the engine, it is possible to suppress a vibration generated by an abrupt change in motor torque when starting the engine, and hence to solve a problem in which a driver feels uncomfortable or unpleasant.

### BRIEF DESCRIPTION OF DRAWINGS

FIG. 1 is a system configuration diagram of a hybrid vehicle (embodiment).

FIG. 2 is a control flowchart of calculating and correcting an inertia compensation torque of the hybrid vehicle (embodiment).

FIG. 3 is a graph illustrating a transition of an engine rotation speed and a motor torque when starting an engine of the hybrid vehicle (embodiment).

FIG. 4 is a graph illustrating a transition of an engine rotation speed and a motor torque when stopping the engine of the hybrid vehicle (embodiment).

### DESCRIPTION OF EMBODIMENTS

Hereinafter, embodiments of the invention will be described by referring to the drawings.

### Embodiment 1

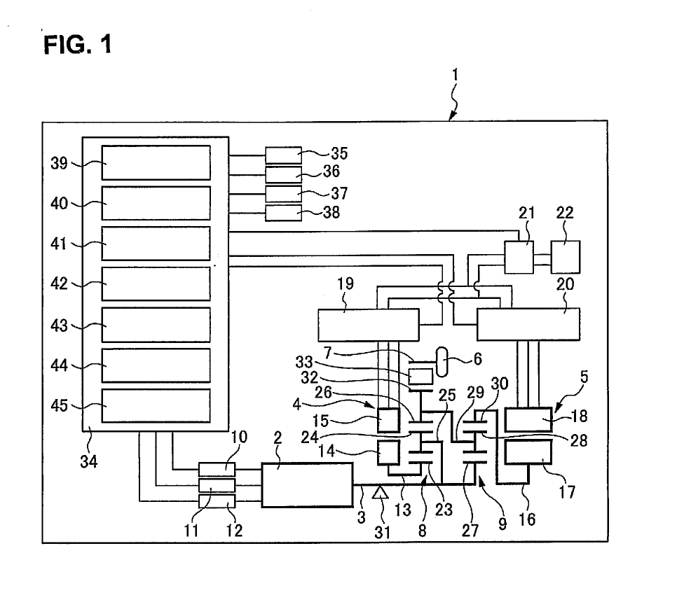

FIGS. 1 to 4 illustrate Embodiment 1 of the invention. In FIG. 1, a hybrid vehicle 1 is provided. The hybrid vehicle 1 includes an output shaft 3 of an engine 2 which generates drive power by the combustion of a fuel, first and second motor generators 4 and 5 which generate drive power by electricity and are driven to generate electric energy, and a drive shaft 7 which is connected to a drive wheel 6 of the hybrid vehicle 1 as a driving system, and includes first and second planetary gear mechanisms 8 and 9 which are connected to each of the output shaft 3, the first motor generator 4, the second motor generator 5, and the drive shaft 7 as a power transmitting mechanism.

The engine 2 includes an air quantity adjusting means 10 which is a throttle valve, or the like, that adjusts an air intake amount corresponding to an accelerator opening degree (an accelerator stepping amount), a fuel supply means 11 which is a fuel injection valve, or the like, that supplies a fuel corresponding to the intake air amount, and an ignition means 12 which is an ignition unit that ignites a fuel. The engine 2 controls the fuel combustion state by the air quantity adjusting means 10, the fuel supply means 11, and the ignition means 12 and generates drive power by the combustion of the fuel.

The first motor generator 4 includes a first motor rotor shaft 13, a first motor rotor 14, and a first motor stator 15. The second motor generator 5 includes a second motor rotor shaft 16, a second motor rotor 17, and a second motor stator 18. The first motor stator 15 of the first motor generator 4 is connected to a first inverter 19. The second motor stator 18 of the second motor generator 5 is connected to a second inverter 20.

The power supply terminals of the first inverter 19 and the second inverter 20 are connected to a battery 22 through a bi-directional DC-DC converter 21. The battery 22 is an electricity storing means which may exchange power with the first motor generator 4 and the second motor generator 5. The electricity amounts from the battery 22 to the first motor generator 4 and the second motor generator 5 through the DC-DC converter 21 are respectively controlled by the first inverter 19 and the second inverter 20. Here, the first and second motor generators generate drive power by the supplied electricity, is driven by the drive wheel 6 in a regeneration mode to generate electric energy, and charges the generated electric energy to the battery 22 through the DC-DC converter 21.

The first planetary gear mechanism 8 includes a first sun gear 23, a first planetary carrier 25 which supports a first planetary gear 24 meshing with the first sun gear 23, and a first ring gear 26 which meshes with the first planetary gear 24. The second planetary gear mechanism 9 includes a second sun gear 27, a second planetary carrier 29 which supports a second planetary gear 28 meshing with the second sun gear 27, and a second ring gear 30 which meshes with the second planetary gear 28.

The first planetary gear mechanism 8 and the second planetary gear mechanism 9 have a configuration in which the rotation center lines of the respective rotation components are coaxially disposed, the first motor generator 4 is disposed between the engine 2 and the first planetary gear mechanism 8, and the second motor generator 5 is disposed so as to be away from the engine 2 in the second planetary gear mechanism 9.

The first motor rotor shaft 13 of the first motor generator 4 is connected to the first sun gear 23 of the first planetary gear mechanism 8. The first planetary carrier 25 of the first planetary gear mechanism 8 and the second sun gear 27 of the second planetary gear mechanism 9 are coupled to each other and are connected to the output shaft 3 of the engine 2 through a one-way clutch 31. The first ring gear 26 of the first planetary gear mechanism 8 and the second planetary carrier 29 of the second planetary gear mechanism 9 are coupled to each other and are connected to an output portion 32. The output portion 32 is connected to the drive shaft 7 through an output transmitting mechanism 33 such as a gear or a chain. The second motor rotor shaft 16 of the second motor generator 5 is connected to the second ring gear 30 of the second planetary gear mechanism 9.

The hybrid vehicle 1 outputs the power generated by the engine 2, the first motor generator 4, and the second motor generator 5 to the drive shaft 7 through the first planetary gear mechanism 8 and the second planetary gear mechanism 9 of the power transmitting mechanism, and drives the drive wheel 6. Further, the hybrid vehicle 1 transmits the drive power from the drive wheel 6 to the first motor generator 4 and the second motor generator 5 through the first planetary gear mechanism 8 and the second planetary gear mechanism 9 of the power transmitting mechanism, generates electric energy, and charges the electric energy to the battery 22.

In this way, the hybrid vehicle 1 transmits and receives the drive power among the engine 2, the first motor generator 4, the second motor generator 5, and the drive shaft 7.

In the hybrid vehicle 1, the air quantity adjusting means 10, the fuel supply means 11, the ignition means 12, the first inverter 19, the second inverter 20, and the DC-DC converter 21 are connected to the vehicle control unit 34. The vehicle control unit 34 is connected with an accelerator opening degree detecting means 35, a vehicle speed detecting means 36, an engine rotation speed detecting means 37, and a battery charge state detecting means 38. Further, the vehicle control unit 34 includes a target engine power calculating means 39, a target charge and discharge power setting means 40, an engine control means 41, and a motor control means 42.

The engine control means 41 controls the drive states of the air quantity adjusting means 10, the fuel supply means 11, and the ignition means 12 so that the engine 2 is operated at an operation point (an engine rotation speed and an engine torque) having good operation efficiency and determined based on the target engine power calculated by the target engine power calculating means 39 from the detection signals of the accelerator opening degree detecting means 35, the vehicle speed detecting means 36, and the engine rotation speed detecting means 37. Further, the motor control means 42 controls the drive states of the first inverter 19 and the second inverter 20 so that the total power of the first motor generator 4 and the second motor generator 5 becomes the target charge and discharge power which is set by the target charge and discharge power setting means 40 based on the charge state (SOC) of the battery 22 detected by the battery charge state detecting means 38.

The vehicle control unit 34 includes at least an engine operation mode and a motor operation mode as a vehicle mode, and controls the operations of the engine 2, the first motor generator 4, and the second motor generator 5 in response to each mode.

The vehicle control unit 34 includes a compensation torque calculating means 43 and a target torque calculating means 44. The compensation torque calculating means 43 outputs the power generated from the engine 2, the first motor generator 4, and the second motor generator 5 to the drive shaft 7 through the first planetary gear mechanism 8 and the second planetary gear mechanism 9 of the power transmitting mechanism, and calculates an inertia compensation torque for compensating an inertia torque which is generated by a change in the rotation speed of the engine 2, the first motor generator 4, and the second motor generator 5. The target torque calculating means 44 corrects the target torques of the first motor generator 4 and the second motor generator 5 based on the inertia compensation torque calculated by the compensation torque calculating means 43.

The compensation torque calculating means 43 corrects the inertia compensation torque when starting the engine or stopping the engine. At this time, the compensation torque calculating means 43 corrects the inertia compensation torque based on the engine rotation speed. Further, the compensation torque calculating means 43 corrects the inertia compensation torque so that the target torques of the first motor generator 4 and the second motor generator 5 become smaller as the engine rotation speed becomes closer to 0 when starting the engine, and corrects the inertia compensation torque so that the target torques of the first motor generator 4 and the second motor generator 5 become smaller as the engine rotation speed becomes closer to 0 when stopping the engine.

The vehicle control unit 34 includes an inertia compensation torque coefficient and an inertia compensation torque moderating coefficient used for the calculation of the inertia compensation torque. Further, the vehicle control unit 34 includes a target motor rotation speed setting means 45 which sets the target motor rotation speeds of the first motor generator 4 and the second motor generator 5.

Next, the operation will be described.

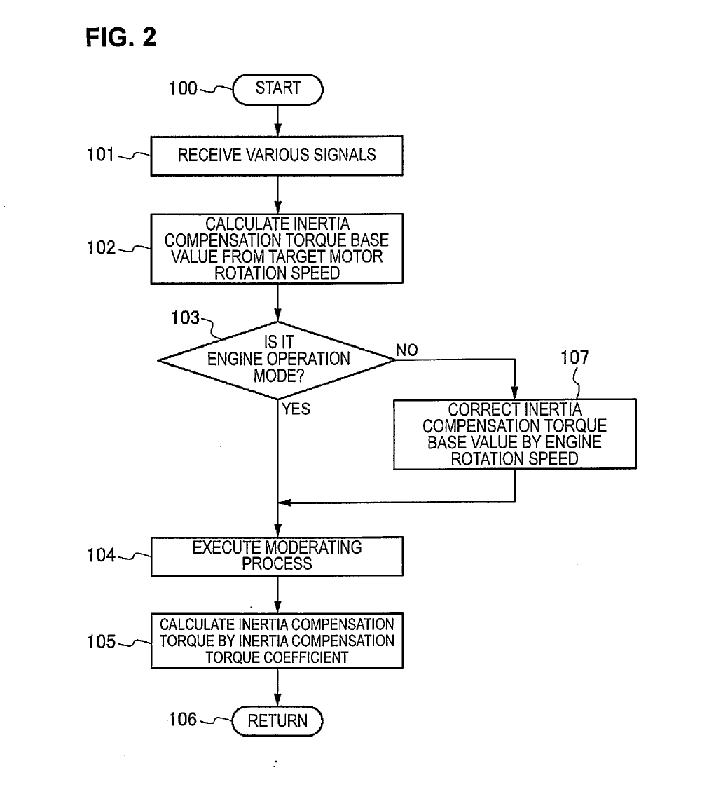

As shown in FIG. 2, the hybrid vehicle 1 executes the control by the vehicle control unit 34. Furthermore, the routine shown in FIG. 2 is periodically executed.

In FIG. 2, when the control is started (100), the vehicle control unit 34 receives the vehicle mode, the target motor rotation speed, the engine rotation speed, the inertia compensation torque coefficient, and the inertia compensation torque moderating coefficient as various signals used for the control (101), calculates the inertia compensation torque base value from the target motor rotation speed (102), and determines whether the current vehicle mode is the engine operation mode (103). This is because the vehicle mode is an engine cranking state (engine startup state) or an engine stop transition state (engine stop state) in a case other than the engine operation mode.

When the determination (103) is YES, a process of moderating the inertia compensation torque base value calculated by step 102 is executed by the inertia compensation torque moderating coefficient (104), the inertia compensation torque is calculated by the inertia compensation torque coefficient set by the engine inertia and the motor inertia from the inertia compensation torque base value subjected to the moderating process (105), and the routine returns (106) to receive various signals (101).

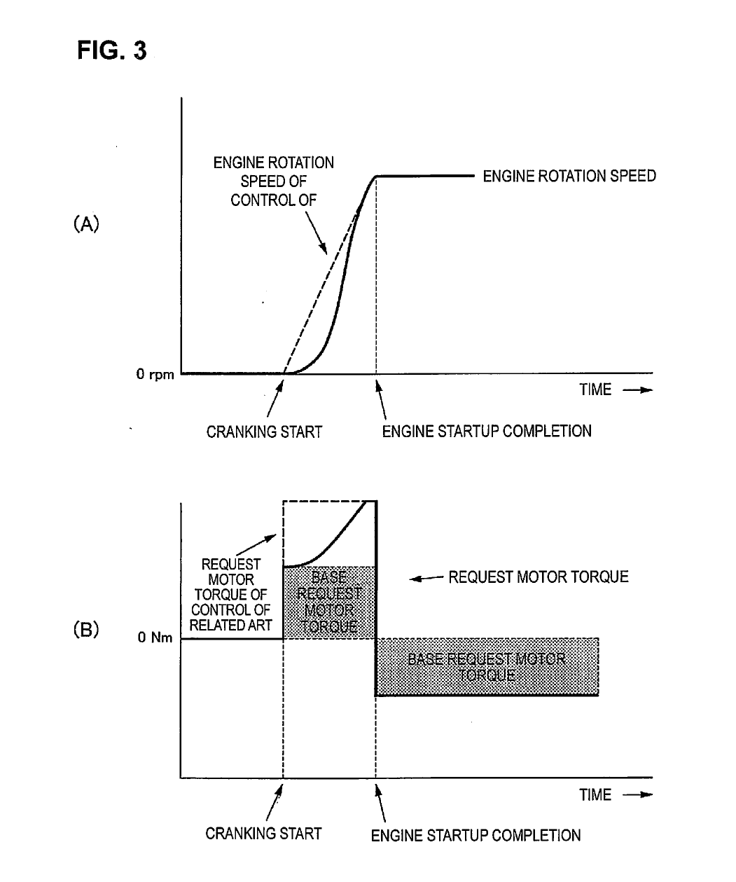

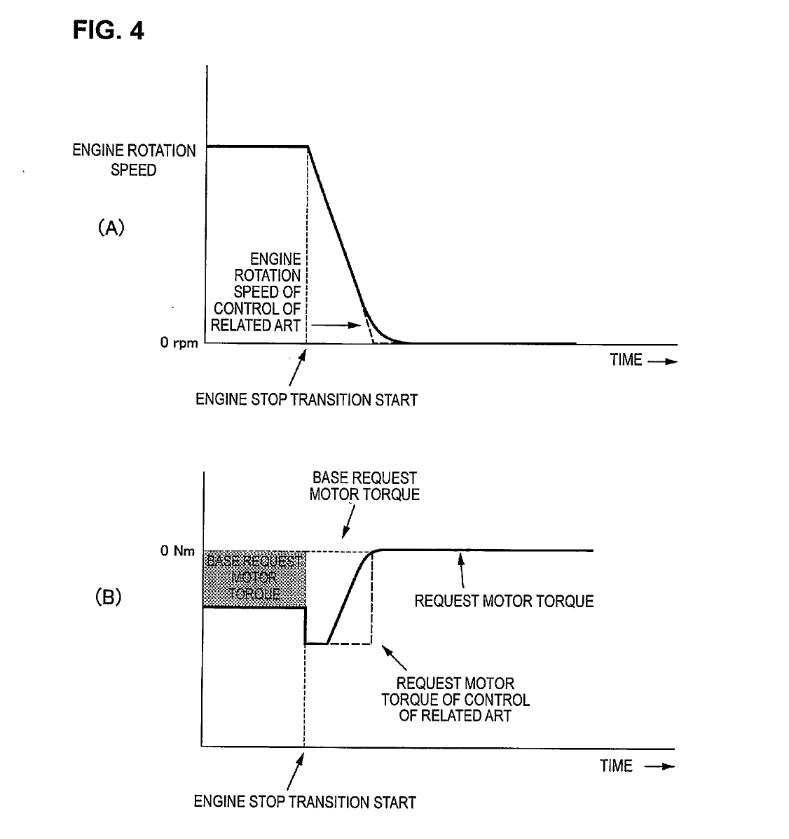

Further, when the determination (103) is NO, the engine state is the engine cranking state (the engine startup state) or the engine stop transition state (the engine stop state), and the inertia compensation torque base value is corrected by the engine rotation speed (107). In this correction, as shown in FIG. 3, the inertia compensation torque is corrected so that the target torques of the first motor generator 4 and the second motor generator 5 become smaller as the engine rotation speed becomes closer to 0 when starting the engine. Further, as shown in FIG. 4, the inertia compensation torque is corrected so that the target torques of the first motor generator 4 and the second motor generator 5 become smaller as the engine rotation speed becomes closer to 0 when stopping the engine.

After the correction by step 107, a process of moderating the corrected inertia compensation torque base value is executed by the inertia compensation torque moderating coefficient (104). Then, the inertia compensation torque is calculated by the inertia compensation torque coefficient set by the engine inertia and the motor inertia from the inertia compensation torque base value subjected to the moderating process (105), and the routine returns (106) to receive various signals (101).

The vehicle control unit 34 corrects the target torques of the first motor generator 4 and the second motor generator 5 by the target torque calculating means 44 based on the inertia compensation torque calculated in step 105.

In this way, the hybrid vehicle 1 may suppress a vibration generated by an abrupt change in motor torque when starting the engine by correcting the inertia compensation torque for compensating the inertia torque generated by a change in the rotation speed of the engine 2, the first motor generator 4, and the second motor generator 5, when starting and stopping the engine and hence may solve a problem in which a driver feels uncomfortable or unpleasant. Further, the invention may suppress a shock generated immediately before stopping the engine when stopping the engine.

Further, since the hybrid vehicle corrects the inertia compensation torque based on the engine rotation speed, a vibration generated when starting and stopping the engine may be effectively suppressed.

Furthermore, since the hybrid vehicle 1 corrects the inertia compensation torque so that the target torques of the first motor generator 4 and the second motor generator 5 become smaller as the engine rotation speed becomes closer to 0 when starting the engine, it is possible to suppress a vibration generated by an abrupt change in torque immediately after starting the engine cranking operation. Further, as shown in FIG. 4, since the hybrid vehicle 1 corrects the inertia compensation torque so that the target torques of the first motor generator 4 and the second motor generator 5 become smaller as the engine rotation speed becomes closer to 0 when stopping the engine, it is possible to suppress a shock generated immediately before stopping the engine. Particularly, in the hybrid vehicle 1 in which the one-way clutch 31 is provided in the output shaft 3 of the engine 2, since the shock generated when stopping the engine is directly transmitted to the drive shaft 7 by using the one-way clutch 31 as a support point, the invention is more effective.

### INDUSTRIAL APPLICABILITY

The invention may suppress the vibration generated by an abrupt change in motor torque when starting the engine and may suppress a shock generated immediately before stopping the engine when stopping the engine. Thus, the invention may be applied to the hybrid vehicle which uses the engine and the motor generator as drive sources.

### REFERENCE SIGNS LIST

1 hybrid vehicle
2 engine
3 output shaft
4 first motor generator
5 second motor generator
6 drive wheel
7 drive shaft
8 first planetary gear mechanism
9 second planetary gear mechanism
19 first inverter
20 second inverter
21 DC-DC converter
22 battery
34 vehicle control unit
41 engine control means
42 motor control means
43 compensation torque calculating means
44 target torque calculating means

1. A hybrid vehicle which outputs power generated from an engine and a motor generator to a drive shaft through a power transmitting mechanism, the hybrid vehicle comprising:
a compensation torque calculating means which calculates an inertia compensation torque for compensating an inertia torque generated by a change in the rotation speed of the engine and the motor generator; and
a target torque calculating means which corrects a target torque of the motor generator based on the inertia compensation torque calculated by the compensation torque calculating means,
wherein the compensation torque calculating means corrects the inertia compensation torque when starting the engine.

2. A hybrid vehicle which outputs power generated from an engine and a motor generator to a drive shaft through a power transmitting mechanism, the hybrid vehicle comprising:
a compensation torque calculating means which calculates an inertia compensation torque for compensating an inertia torque generated by a change in the rotation speed of the engine and the motor generator; and
a target torque calculating means which corrects a target torque of the motor generator based on the inertia compensation torque calculated by the compensation torque calculating means,
wherein the compensation torque calculating means corrects the inertia compensation torque when stopping the engine.

3. The hybrid vehicle according to claim 1,
wherein the compensation torque calculating means corrects the inertia compensation torque based on an engine rotation speed.

4. The hybrid vehicle according to claim 3,
wherein the compensation torque calculating means corrects the inertia compensation torque so that the target torque of the motor generator becomes smaller as the engine rotation speed becomes closer to 0 when starting the engine and corrects the inertia compensation torque so that the target torque of the motor generator becomes smaller as the engine rotation speed becomes closer to 0 when stopping the engine.
